(19) United States
(12) Patent Application Publication
(10) Pub. No.: US 2003/0007507 A1
(43) Pub. Date: Jan. 9, 2003

(54) Data streaming

(76) Inventors: Doron Rajwan, Givataim (IL); Eyal Lubetzky, Givataim (IL)

Correspondence Address: William H Dippert, REED SMITH LLP, 599 LEXINGTON AVE., 29th floor, New york, NY, 10022, US

(21) Appl. No.: 09/958,165

(22) PCT Filed: Feb. 2, 2001
(86) PCT No.: PCT/IL01/00106

(30) Foreign Application Priority Data
Aug. 1, 2000 (IL) 137624
Aug. 27, 2000 (IL) 138114
Dec. 24, 2000 (IL) 140504

(51) Int. Cl. H04J 3/16

(52) U.S. Cl. 370/468; 370/470

(57) ABSTRACT

A method of transmitting a data file over a communication medium (100), comprising determining relative desired reconstruction time frames for different parts of the file, allocating different transmission rates for the different parts of the file responsive to said determining, dividing the file into sections, encoding the sections using a FEC (forward error correction) code having the property that a file section can be reconstructed once a sufficient amount of encoded data relating to that data section is received (104), and transmitting the encoded sections to have effective retransmission rates matching said different retransmission rates (102), such that the parts can be reconstructed in their respective desired time frame.

### RELATED APPLICATIONS

This application is related to and claims the benefit under 35 USC 119(e) of U.S. Ser. No. 60/179,926 filed on Feb. 3, 2000, U.S. Ser. No. 60/217,139 filed on Jul. 10, 2000, U.S. Ser. No. 60/245,000 filed on Nov. 1, 2000 and U.S. Ser. No. 60/245,098 filed on Nov. 2, 2000. This application is also related to Israeli applications 137,624 filed on Aug. 1, 2000, 138,114 filed on Aug. 27, 2000 and 140,504 filed Dec. 24, 2000. This application is also related to two PCT applications filed on even date and by same applicant as the instant application, having attorney docket numbers 212/02064 and 212/02063. The disclosure of all of these applications is incorporated herein by reference.

### FIELD OF THE INVENTION

The present invention is related to the transmission of stream information over a communication channel.

### BACKGROUND OF THE INVENTION

Many media types are typically provided in a streaming mode, for example movies and audio. An advantage of streaming is that there is substantially no delay at a receiver before the media can be previewed, providing the media stream is sent in a manner synchronized to the viewing. If a user is required to wait for a media stream to repeat itself, for example in a carousel transmission system, the delay is as long as the transmission repeat time.

Another type of media dissemination method is multicasting, which may be combined with streaming. A single copy of the media stream is broadcast to a plurality of receivers. In some implementations, a complete file is transmitted by multicasting, without streaming, or is repeatedly transmitted.

Another type of data dissemination method is “on-demand” transmission. The transmission of data is synchronized with a request by a user. This type of dissemination is provided by unicasting (point to point connection). Alternatively, a receiver can select a start time, out of a small number of available times, at each of which times a complete retransmission of the data is performed. A particular application of “on-demand” dissemination is cable broadcasting of movies. In some implementations, a complete file may be transmitted “on-demand”, for viewing when convenient. In such a file transmission system, if a media file size is FS and an available transmission bandwidth is TB, a minimally expected delay before the file can be played back is FS/TB.

The following references describe methods of video on demand, their disclosures are incorporated herein by reference:

Darrell D. E. Long, Jehan-Francois Paris, Steven W. Carter “http://csl.cse.ucse.edu/projects/video-on-demand/” present insight regarding video on demand and different transmission protocols (Harmonic Broadcasting, Pagoda Broadcasting), available on Jan. 9, 2001.

C. C. Aggarwal and J. L. Wolf and P. S. Yu. “A Permutation-Based Pyramid Broadcasting Scheme for Video-On-Demand Systems”. Proc. Of the IEEE Int'l Conf. On Multimedia Systems. June 1996.

C. C. Aggarwal and J. L. Wolf and P. S. Yu. “On Optimal Batching Policies for Video-on-Demand Storage Server” Proc. Of the IEEE Int'l Conf. On Multimedia Systems. June 1996.

S. Viswanathan and T. Imielinski. “Metropolitan Area Video-On-Demand Service Using Pyramid Broadcasting”. IEEE Multimedia Systems. 4:197-208, 1996.

K. A. Hua and S Sheu. “Skyscraper Broadcasting: A New Broadcasting Scheme for Metropolitan Video-On-Demand Systems”. ACM SIGCOMM. Sept. 1997.

A. Dan and P. Shahabuddin and D. Sitaram, “Scheduling policies for an on-demand video server with batching”. In Proc. Of ACM Multimedia, October 1994, pp. 168-179.

A. Dan and D. Sitaram and P. Shahabuddin, “Dynamic Batching Policies for an On-Demand Video Server”. In Multimedia Systems, 4:112-121, June 1996.

L. Gao, J. Kurose, D. Towsley, “Efficient Schemes for Broadcasting Popular Videos”, Proceedings of NOSSDAV, Cambridge, UK, July 1998.

D. L. Eager and M. K. Vernon, “Dynamic Skyscraper Broadcasts for Video-On-Demand”, Technical Report #1375, Computer Science Department, UW-Madison, May 1998.

### SUMMARY OF THE INVENTION

An aspect of some embodiments of the invention relates to a media transmission method in which a desired tradeoff can be achieved between an expected delay in reception (of a file) and an available transmission and/or reception bandwidth, for example in a streaming system. In an exemplary embodiment of the invention, no feedback from the receiver is required for synchronizing the transmission with the reception. In an exemplary embodiment of the invention, a minimal delay is determined for any provided bandwidth.

In an exemplary embodiment of the invention, a file is viewed as including urgent parts that need to be received earlier and parts that can be received later. In an exemplary embodiment of the invention, the urgent parts of the file are transmitted (or received) and/or multicast at a higher effective transmission rate, at the expense of the less urgent parts. Thus, all else being equal, the urgent parts can be displayed sooner. In an exemplary embodiment of the invention, the less urgent parts are received and/or processed, during the reception and playback of the urgent parts. A lower transmission rate can thus be tolerated for the less urgent parts, as a longer reception time is available. Optionally, the relative rates of transmission are selected to take into account the total bandwidth, so that a continuous playback is possible, possibly while minimizing an expected startup delay.

In an exemplary embodiment of the invention, the definition of less urgent and more urgent parts is continuous over the file, with multiple intermediate levels of urgency. Optionally, in a media file, relative urgency is defined based on ordinal location in file. Alternatively or additionally, relative urgency may be defined based on information content, for example in newscast files. Alternatively or additionally, relative urgency may be defined based on relative contribution to the content, for example of transform coefficients in compressed files.

In an exemplary embodiment of the invention, unequal transmission rates are achieved by dividing the file up into blocks, and transmitting the different blocks at different transmission and/or repetition rates. A block may be transmitted, for example, as a series of packets. Alternatively or additionally, the file is divided up into different sized blocks, which are each transmitted using the same bandwidth and thus different blocks take different amounts of time to transmit. Alternatively or additionally, urgent bits of the file take parts in more transmitted packets than other bits. Intermediate embodiments, such as different size blocks at different data and/or block rates, are also possible.

In an exemplary embodiment of the invention, the media transmission method includes segmenting a media file into N blocks of unequal sizes. Optionally, the sizes of the blocks are of increasing size, each block being larger by a factor than a previous block, i.e., the blocks have an exponentially increasing size. Optionally, the factor is two. Thus, for example, a 15MB file can be divided into a 1MB block, a 2MB block, a 4MB block and a 8MB block. Each of these blocks (optionally encoded and/or sent as packets) is repeatedly transmitted on a separate channel. Optionally, the data rate of transmissions is the same or smaller than that required for real-time playback of the file. At a receiver a plurality of file blocks are received in parallel, such that packets from one block are received before all the packets from another block are received. The expected delay time is the time required to receive the smallest part. While the smallest part is being received and played, a second larger part can be received, and so, the effect is that of streamed playback. In some embodiments, the expected delay can be even shorter than the time for receiving a smallest block, for example using preferential encoding as described below.

In an exemplary embodiment of the invention, the expected delay goes down exponentially as a function of the provided bandwidth, rather than linearly, as might otherwise be expected.

In an exemplary embodiment of the invention, the above media transmission method is used for multicasting on a communication network, for example a cable network, a satellite network, a cellular telephone network or other types of wired and/or wireless transmission networks. Alternatively or additionally, this transmission method is used for unicasting, for example if synchronization between a source and a receiver are difficult and a streaming effect with a short expected delay is desired.

Optionally, the transmission is a packet based transmission. Alternatively or additionally, a FEC (forward error correction code) is used, so that a stream can be reconstructed from any set of received transmissions. Alternatively, a bit transmission based method is used.

Alternatively or additionally, such an error-correction code is used to allow a slower playback, especially by receivers having a limitation on the number of channels they can receive at a time. Thus, in some embodiments of the invention, either the transmitter or the receiver may be limited to sending or receiving fewer than a desired number of streams in parallel. In some embodiments of the invention, a plurality of independent transmitters are provided, each transmitting its own stream(s), such that the combination of streams yields a viable data packet.

In an equal-block size embodiment, the blocks for a file are encoded into packets, with packets for the beginning of the file sent out at a higher rate than packets for the end of the file. A harmonic series may be used to define the relative transmission rate, as a function of file position. The packets may be sent on a single or a plurality of channels.

In some embodiments of the invention, a file is transmitted in a manner that supports at least one starting point (e.g., an entry point) other than the file beginning. Different entry points may have same or different expected delays. In an exemplary embodiment of the invention, a plurality of entry points is provided by using a non-monotonic function to describe the block sizes, block transmission rates and/or other data-preferential transmission methods described herein. Thus, the packets relating to the entry points are more likely to be received faster than the others and a smaller expected delay is thus achieved for those points.

In an exemplary embodiment of the invention, a real-time stream is transmitted by providing both the original start of the stream and the instant point of the stream as preferential bits. As the stream continues, the preferential transmission of the previous point is diluted by further transmission. In an exemplary embodiment of the invention, packets are created on the fly from the stream as it arrives. Optionally, the packets are first transmitted as unencoded packets and, when retransmitted, transmitted as encoded packets, for example, including the encoding of previous or later sections of the stream.

An aspect of some embodiments of the invention relates to efficient reception of a stream by a receiver having a limited bandwidth. In an exemplary embodiment of the invention, the receiver is forced to received unnecessary data, as the data is sent in a manner unsynchronized to the reception and playback of the receiver, for example, as multicast data to multiple receivers. However, if the transmitted bandwidth is greater than the received bandwidth, the receiver can focus on those parts of the transmission that relate to what is more urgent. In an exemplary embodiment of the invention, a small overhead in the reception (e.g., 10% or 20%) can allow a relatively short delay in reception, nearly comparable to the delay achievable if the receiver bandwidth matched the transmission bandwidth.

An aspect of some embodiments of the invention relates to smooth display of a file transmitted over a channel with varying bandwidth. In an exemplary embodiment of the invention, multiple parts of the file are transmitted in parallel. Optionally, there is overlap between the different parts of the file.

There is therefor provided in accordance with an exemplary embodiment of the invention, a method of transmitting a data file over a communication medium, comprising:

determining relative desired reconstruction time frames for different parts of the file;

allocating different transmission rates for the different parts of the file responsive to said determining;

dividing said file into sections;

encoding said sections using a FEC (forward error correction) code having the property that a file section can be reconstructed once a sufficient amount of encoded data relating to that data section is received; and

transmitting the encoded sections to have effective retransmission rates matching said different retransmission rates, such that said parts can be reconstructed in their respective desired time frame. Optionally, said sections have equal sizes. Alternatively, sections have unequal sizes. Optionally, the sizes of consecutive sections are related by a same factor.

In an exemplary embodiment of the invention, said sections are transmitted at different retransmission rates. Alternatively, said sections are transmitted at same retransmission rates.

In an exemplary embodiment of the invention, said sections are transmitted as packets. Optionally, different packets from a same section are transmitted at a different rate.

In an exemplary embodiment of the invention, said encoding represents at least one bit of a section at a higher effective rate that a different bit of said section.

In an exemplary embodiment of the invention, the method comprises receiving said stream using a receiver with an effective bandwidth more limited than the bandwidth used for said retransmission. Optionally, said receiver has an effective bandwidth less than 1.5 times a playback bandwidth required for real-time playback of said file and said retransmission has an effective bandwidth of over 2 times the playback bandwidth. Alternatively or additionally, said receiver has an effective bandwidth less than 1.5 times a playback bandwidth required for real-time playback of said file and said retransmission has an effective bandwidth of over 4 times the playback bandwidth.

In an exemplary embodiment of the invention, portions of said file in different sections overlap. Alternatively or additionally, at least one of said encoded sections refers to content in more than one section.

There is therefor provided in accordance with an exemplary embodiment of the invention, a method of transmitting a data file over a communication medium, comprising:

determining relative desired reconstruction time frames for different parts of the file;

allocating different retransmission rates for the different parts of the file responsive to said determining so that an effective retransmission rate varies on a bit by bit basis; and

transmitting the file so that said different parts have effective retransmission rates matching said different retransmission rates, such that said parts can be reconstructed in their respective desired time frame.

There is therefor provided in accordance with an exemplary embodiment of the invention, a method of transmitting a data file over a communication medium, comprising:

determining relative desired reconstruction time frames for different parts of the file;

allocating different retransmission rates for the different parts of the file responsive to said determining so that retransmission rate varies continuously on a data block by data block basis; and

transmitting the file so that said different parts have effective retransmission rates matching said different retransmission rates, such that said parts can be reconstructed in their respective desired time frame.

There is therefor provided in accordance with an exemplary embodiment of the invention, a method of transmitting a data file over a communication medium, comprising:

determining relative desired reconstruction times for different parts of the file;

differentially allocating different retransmission rates for the different parts of the file responsive to said determining;

dividing the file into sections; and

transmitting the file so that said different parts have effective retransmission rates matching said different retransmission rates, said retransmission using a multi-layer retransmission scheme, such that said parts can be reconstructed in their respective desired time frame. Optionally, said different layers contain the same data. Alternatively, said different layers contain data, to allow bandwidth dependent reception of different levels of reception quality, dependent on the bandwidth received by a receiver.

In an exemplary embodiment of the invention, transmitting comprises encoding said sections using a FEC (forward error correction) code having the property that a file section can be reconstructed once a sufficient amount of encoded data relating to that data section is received.

There is therefor provided in accordance with an exemplary embodiment of the invention, a method of transmitting a data file over a communication medium, comprising:

determining relative desired reconstruction time frames for different parts of the file;

differentially allocating different retransmission rates for the different parts of the file responsive to said determining;

dividing the file into sections having different sizes; and

transmitting the sections to have effective retransmission rates matching said different retransmission rates.

In an exemplary embodiment of the invention, said transmitting is oblivious to a time of commencement of said receiving. Optionally, transmitting comprises multicasting.

In an exemplary embodiment of the invention, said data file comprises a video stream.

In an exemplary embodiment of the invention, said data file comprises an audio stream.

In an exemplary embodiment of the invention, said data file comprises a streaming media.

In an exemplary embodiment of the invention, said data file comprises a real-time stream.

There is therefor provided in accordance with an exemplary embodiment of the invention, a method of transmitting and receiving a data file in a manner oblivious to a time of commencement of reception by a receiver, comprising:

transmitting a file, using a retransmission bandwidth, such that different parts of the file are retransmitted at different rates; and

receiving said file using an effective reception bandwidth, smaller than said retransmission bandwidth, said transmitting being oblivious to a time of commencement of said receiving; and

commencing continuous playback of said file, at a delay from said retransmission, wherein said reception bandwidth is less than 80% of said retransmission bandwidth and wherein a ratio between said delay and a playback time of said file is smaller than 80% of a ratio between said reception bandwidth and said retransmission bandwidth. Optionally, said reception bandwidth is less than 50% of said retransmission bandwidth. Alternatively or additionally, said reception bandwidth is less than 20% of said retransmission bandwidth. Alternatively or additionally, said reception bandwidth is less than 200% of a bandwidth required for smooth playback of said file using a synchronized transmission method. Alternatively or additionally, said reception bandwidth is less than 150% of a bandwidth required for smooth playback of said file using a synchronized transmission method. Alternatively or additionally, said reception bandwidth is less than 130% of a bandwidth required for smooth playback of said file using a synchronized transmission method.

In an exemplary embodiment of the invention, said transmission is a multi-channel transmission and wherein said receiver is limited in a number of channels it can receive, said number being smaller than the number of channels being used for transmission.

Optionally, receiving comprises optimizing said receiving, within the limits of said effective reception bandwidth to minimize said delay.

In an exemplary embodiment of the invention, receiving comprises limiting said reception to data required for current playback and for temporally sequential playback.

There is therefor provided in accordance with an exemplary embodiment of the invention, a method of streaming real-time data, as it is being provided, comprising:

providing an input stream of real-time data;

generating packets based on said real-time data; and

transmitting, in parallel, packets relating to a time frame of said stream and to a previous time-frame of said stream, such that packets are transmitted at an effective bit retransmission rate depending on a relative time frame of data in said packets. Optionally, generating comprises encoding said data using FEC (forward error correction) code having the property that a file section can be reconstructed once a sufficient amount of encoded data relating to that data section is received. Optionally, generating comprises generating unencoded packets for current time frame packets.

In an exemplary embodiment of the invention, the effective retransmission rates are selected so that at least one entry point in said stream will be retransmitted at a higher effective retransmission rate than non-entry points of said stream and data from time frames following said at least one entry point will have monotonicly decreasing effective retransmission rates, at least until a next entry point. Optionally, the current time flame is an entry point. Alternatively or additionally, the beginning of the stream is an entry point.

In an exemplary embodiment of the invention, transmitting comprises transmitting different packets at different repetition rates. Alternatively or additionally, transmitting comprises preferentially selecting some data over others in a generation of said packets for transmission.

There is therefor provided in accordance with an exemplary embodiment of the invention, a method of transmitting a data file over a communication medium, comprising:

determining relative desired reconstruction time frames for different parts of the file;

differentially allocating different retransmission rates for the different parts of the file responsive to said determining; and

transmitting the file so that said different parts have effective retransmission rates matching said different retransmission rates, over a channel with a varying bandwidth. Optionally, the method comprises dividing the file into sections, each of which is transmitted at a different effective retransmission rate. Optionally, at least two of said sections include an overlapping part of said file. Alternatively or additionally, the method comprises generating data packets including contributions from different sections.

In an exemplary embodiment of the invention, the method comprises:

receiving said transmission; and

commencing playback of said file, as it is being received, at a delay relative to said reception, said delay being smaller than that required for receiving 50% of said file.

Optionally, the method comprises selecting said delay responsive to expected variations in said bandwidth. Alternatively or additionally, the method comprises selecting said relative retransmission rates responsive to expected variations in said bandwidth. Alternatively or additionally, the method comprises modifying a quality of data in said transmission responsive to expected variations in said bandwidth.

### BRIEF DESCRIPTION OF THE DRAWINGS

Non-limiting exemplary embodiments of the invention will be described in following description of exemplary embodiments, read in conjunction with the accompanying figures. Identical structures, elements or parts that appear in more than one of the figures are labeled with a same or similar numeral in all the figures in which they appear.

FIG. 1 is a schematic illustration of a data streaming configuration, in accordance with an exemplary embodiment of the invention.

FIG. 2 is a schematic illustration of a file split up for transmission in accordance with an exemplary embodiment of the invention; and

FIG. 3 is a flowchart of a method of reconstructing a transmitted data file, transmitted by streaming in accordance with an exemplary embodiment of the invention.

### DETAILED DESCRIPTION OF EXEMPLARY EMBODIMENTS

Overview

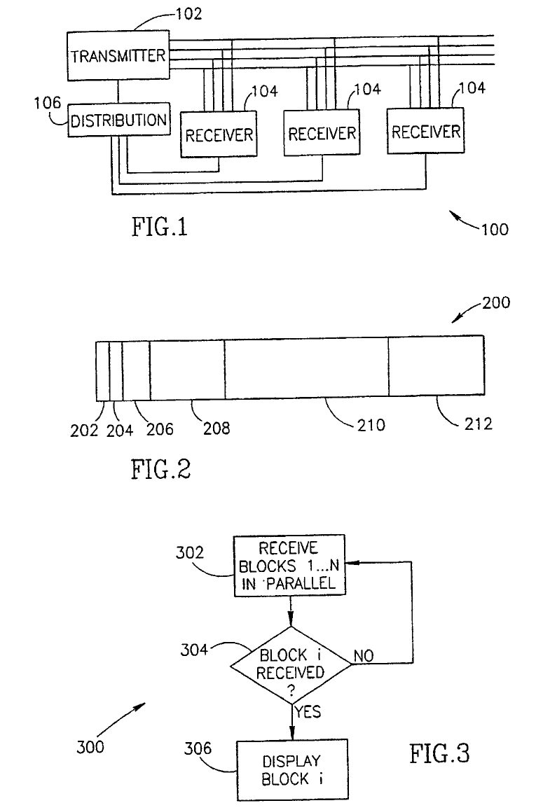

FIG. 1 is a schematic illustration of a data streaming configuration 100, in accordance with an exemplary embodiment of the invention. One or more transmitters 102 transmit a file as a plurality of streams of data or data packets. In some embodiments of the invention, each such stream is multicast. Alternatively or additionally, each stream is repeatedly transmitted, for example using a data carousel or a forward error correction code, as will be described in more detail below.

One or more receivers 104 receive the data streams and reconstruct a copy of the transmitted file. An optional distribution controller 106 is described below.

In an exemplary embodiment of the invention, a receiver 104 includes a local storage unit, for example one or more disks, for storing received parts of the data stream, until they are needed for reconstructing and/or display.

Exemplary File Division

FIG. 2 is a schematic illustration of a file 200 split up for transmission in accordance with an exemplary embodiment of the invention. As shown in FIG. 2 file 200 is split into blocks 202, 204, 206, 208, 210 and 212, which are not all the same size. In an exemplary embodiment of the invention, each part of the file is larger by a factor than a previous part, for example a factor of two. The last block may or may not fit this criterion, for example including only a residual portion of file 200. As will be described below, the size of the factor may depend, inter alia, on the ratio between transmission speed and playback. The factor can be lower than or higher than two.

The number of blocks into which file 200 is divided may be determined, for example, by the number of parallel streams available or the ability of the receivers to receive parallel streams. In some embodiments of the invention, as the number of blocks increases, the expected delay before the file can be played back is smaller. In some embodiments of the invention, the expected delay time can be as short as

$$DT = \frac{FS}{{e}^{nBW} - 1} ,$$

where DT is the delay time, FS is the file size and nBW is the ratio between the total available bandwidth and the bandwidth required for real-time playback. It is noted that smooth playback (e.g., for a limited time and/or after a sufficient delay) is also possible in some cases where the total available bandwidth is smaller than the play-back bandwidth. In some embodiments of the invention, the relationship between the number of blocks, BK, and delay time is

$$DT = \frac{FS}{{( 1 + nBW / BK )}^{BK} - 1} .$$

Thus, as a file is divided into more blocks (relative to the number of streams), the expected delay approaches an “e” base exponent. In some applications, a base of at least 2 or even 2.25 is achieved. Although the relationship between bandwidth and delay is exponential, by properly selecting the block sizes (and/or transmission rates) other relationship, such as quadric or higher power, can be achieved.

File Reconstruction

FIG. 3 is a flowchart 300 of a method of reconstructing a transmitted data file, transmitted by streaming in accordance with an exemplary embodiment of the invention. At 302, a plurality of N of the available K blocks into which the file is divided (possibly, K>>N, optionally K=N) are received in parallel. At 304, if an I'th block is received, it is displayed (306), while continuing to receive the other blocks in parallel. Generally, as the blocks are in ascending order, the blocks will also complete reception in order. If a block is missing, some frames may be skipped, or the playback delayed until the required blocks are received. By selecting a factor of two between block sizes and assuming a real-time transmission rate for each stream, the following effect is achieved: the time that it takes to receive and display a block is the same as the time it takes to receive the next block. Thus, when the display of a first block is completed, the consecutive block is now ready for display. Optionally, the factor is smaller than 2.

It should be noted that in some embodiments, channels are received at a rate lower than the bandwidth required for real-time playback.

Block Size and Delay

In some embodiments of the invention, the size of the smallest block and/or the complete block distribution are selected to achieve a desired expected delay. Alternatively or additionally, the block size(s) are selected in conformance with transmission channel limitations and/or limitations on the availability of multicast address names.

Carousel

In some embodiments of the invention, the blocks are sent as consecutive bits, possibly arranged in packets. In each stream, the bits are repeatedly sent. However, if any bits are missed, a complete cycle must be waited. In addition, in a streaming mode, a minimum expected delay is the time to receive a complete cycle.

FEC Transmission

Alternatively in an exemplary embodiment of the invention, the data is sent using a FEC (forward error correction) code, in which a message of N bits can be reconstructed if any N bits (possibly plus a small overhead) are received. Data can begin to be usefully accumulated from the very first received bit. In addition, if any bits are lost, the following bits can replace them. Exemplary FECs are described for example in Internet draft number draft-ietf-rmt-bb-fec-02 (Nov. 17, 2000), the disclosure of which is incorporated herein by reference.

In an exemplary encoding scheme, in accordance with one embodiment of the invention, a data packet is generated by XORing together a plurality of data sections from the file (each data section is possibly the size of a channel block, while the division into blocks described above, can be unrelated). The selection of data sections to use in each packet, can depend, for example, on the location of the section relative to the start of the file. In an exemplary embodiment of the invention, the percentage of data sections used for a packet in a particular file section (described below) or file block is smaller than 50%, for example, being less than 5%, 10%, 20% or 30%.

In an exemplary decoding method, a set of equations is solved, using the received packets as input. A random number generation seed may be provided with each packet, to indicate which data sections of the original files take part in the packet. In an exemplary embodiment of the invention, the file is divided into sections, and separate packets are generated for each section. These sections may overlap the file blocks or may be considerably smaller. Possibly, packets from earlier sections, may be sent at a higher rate than packets from later sections and/or the section sizes may vary along the file. In an exemplary embodiment of the invention, cross-section packets are also provided, which packets combine data between different sections. Such packets are useful in that they allow to propagate the reconstruction of file section into another file section, even if some packets are missing from the other section. In the streaming implementations, such packets may assist in providing a limited look-ahead ability and/or compensate for missing packets. In an exemplary embodiment of the invention, the cross-section packets are limited to file sections that have similar ordinal numbers.

Preferential Encoding and Transmission

Alternatively or additionally to varying block sizes in order to achieve preferential reception of earlier blocks of the file, same size blocks may be used, with higher transmission rates of packets from the earlier blocks of the file. For example, preferential reception can be achieved by sending packets relating to earlier blocks more often than packets relating to later blocks. Thus, sufficient packets to reconstruct a first block of the file will generally be received sooner than packets required for reconstructing a later part of the file. The expected delay indicates the expected amount of time to accumulate sufficient packets. The above block size factor is translated, in this embodiment, into a relative packet transmission rate. Alternatively or additionally, a combined measure of packet transmission rate and relative block size can be used, to control the relative temporal availability (at the receiver) of different parts of the file.

Alternatively or additionally, preferential encoding schemes, in which one part of the file takes part in more packets than other parts of the file, may also be used to ensure faster reception of those parts. Preferential encoding can be applied to any part of the file, and/or any size units.

It should be noted that a same cost in overhead of preferential encoding may be used to provide a small number of bits with a high additional preference or a large number of bits with a small additional preference. Possibly, different bits in the file are provided with different preference levels, possibly many levels used in a single file. In an exemplary embodiment of the invention, the preference level of consecutive bits is smoothly decreasing, so that the transmission load of the bits is smoothly decreasing.

One potential problem with block-based transmission rate varying methods for achieving preferential reception is that all the bits in a same block have the same preference level, even though the earlier bits in the block often are more urgent than the later bits (for displaying a stream). Although reducing the block size can better match the preference levels and the bit positions, this may not be practical.

In an exemplary embodiment of the invention, preferential encoding is used in the transmission of a single block of the file, to ensure that earlier bits of the block are available for decoding sooner than later bits. Possibly, such preferential encoding is used in conjunction with block based or packet based preferential transmission methods, to achieve more optimal usage of the variable bandwidth, possibly approaching the above “e” based theoretical limit. This method may be used even if the file is transmitted as a single block.

Another potential advantage of bit level preferential encoding is that the preference level of a bit can be changed simply by using it less or more often in later packets (equations).

Congestion Control

One potential problem in a streaming system is that congestion can form at various parts of the network. In an exemplary embodiment of the invention, receiver driven congestion control is used, in which the receiver responds to reduce the congestion. Alternatively or additionally, centrally driven or router driven congestion control is used.

In an exemplary embodiment of the invention, a simple form of congestion control is applied, in that a router that notes congestion can freely drop any packet. The use of FEC implies that no particular dropped packet was of any importance.

In an exemplary embodiment of the invention, the different rate channels are layered. In one method, all the channels include the same content, albeit at different rates Alternatively, different channels contain different packets of the same content, therefore the receiving agent can disconnect itself from some of the channels to eliminate or reduce congestion.

In a different method, some channels include data not found in other channels, for example, data for reconstructing a higher quality stream. Alternatively, the content is distributed between the channels thus packets from all channels are required for reconstructing the complete data. In this method channels with data that is only required at a later time can be disconnected temporarily and reconnected at a later time without effecting the final result if reconnected in time. This method may also be useful in multi-resolution streams, in which the highest resolution requires all the channels to be attended to. In case of congestion over a long period some channels can be disconnected and the resolution allowed to decrease while maintaining continuos playback.

It should be noted that if a FEC code is used, using layering does not necessarily add significant overhead or bandwidth requirements to the transmission system.

The following papers describe applications of layering, their disclosures are incorporated herein by reference: S. McCanne, V. Jacobson and M. Vetterli “Receiver Driven Layered Multicast” ACM SIGCOMM, pp. 117-130, 1996, Rubenstein, Dan, Kurose, Jim and Towsley, Don, “The Impact of Multicast Layering on Network Fairess”, Proceedings of ACM SIGCOMM'99, L. Vicisano, L. Rizzo, J. Crowcroft, “TCP-like Congestion Control for Layered Multicast Data Transfer”, IEEE Infocom '98, San Francisco, Calif., Mar. 28-Apr. 1, 1998 and Vicisano, L., “Notes On a Cumulative Layered Organization of Data Packets Across Multiple Streams with Different Rates”, University College London Computer Science Research Note RN/98/25, Work in Progress (May 1998).

Delay Prevention

In streaming applications, it is typically required that a bit should not only be available before the next bit in the stream, but that the bit should also be available on time for display.

In some cases, an anticipated bandwidth is not available or an unexpected event reduces the available bandwidth. This might cause an unexpected delay at the receiver, in that the bit is not available on time for display.

In some stream types, bits that are not available can be dropped, for example, in some multi-resolution video streams. Alternatively or additionally, the stream may be paused until the bit, or a sufficient string of bits is available. Alternatively or additionally, at least in some stream types the bit may be estimated, for example, based on previous or neighboring bits.

Alternatively, the delay is avoided. In one exemplary embodiment of the invention, the size factor of blocks (or other method of controlling block sizes) in the file is made smaller than would be possible using the available bandwidth, so that a next block can be available for decoding sooner than the completion of presentation of a previous block. Thus, if an unexpected delay occurs in the reception of the next block, a small delay in block presentation does not affect its display on time.

In an exemplary embodiment of the invention, when congestion is anticipated and/or detected during the transmission of a file, the original file is re-divided into a different set of blocks (e.g., larger blocks and/or a different size factor), so that smooth playback, is maintained, albeit at a lower rate and/or greater delay.

In an exemplary embodiment of the invention, bit level preference setting or resetting is used, in that previously transmitted bits are transmitted less often in the future, so that a desired preference level is achieved for those bits.

Data Type Specific Applications

Many of the embodiments described herein assume that an importance of a bit is monotonicly determined by its position in the stream. However, in some data types, the importance of a bit may depend on other factors as well. For example, in a stream of MPEG, in each frame, some bits arc more important than others.

In an exemplary embodiment of the invention, the encoding method is tailored to the data type that is being transmitted. For example, a block of the file is divided into sub-blocks having bits of different importance levels, with each sub-block being transmitted at a different rate. Possibly, the transmission level of a sub-block of important bits from a later block is higher than the transmission rate of a sub-block with low importance bits from a previous block.

Alternatively to modifying the encoding scheme, in an exemplary embodiment of the invention, the stream is reorganized prior to being encoded so that it conforms to the rule that earlier bits in the stream are more important than later bits. When the stream is received it may be reorganized back to its original form (possibly, less any bits that did not arrive on time). Optionally, the reorganizing before the decoding and after the decoding are performed by data-dependent pre- and post- processing units (e.g., software and/or hardware).

Multiple Entry Points

The above method is especially useful for files that are viewed starting at their beginning. For files with multiple entry points, the file may be treated as a plurality of sub files, each with its own starting point having its own expected delay.

Multiple entry points can also be provided by varying the packet transmission rate over the file, for example providing greater transmission rates at the desired entry points. Alternatively or additionally, to control packet transmission rates, other preferential encoding schemes can be used, for example using earlier blocks of the file in a greater percentage of the packets.

In some embodiments of the invention, when a user stops viewing a media file, the last block and the previously received un-displayed blocks are saved, so that continued viewing of the file can resume with a short or substantially no delay. Alternatively or additionally, a user may use the previously received packets for a playback function. Optionally, for points in the file where playback is expected, the file structure is inverted in time, with earlier blocks being short and/or transmitted more often, so that playback can be rapid. Alternatively or additionally, packets received and relating to later blocks of the file, may be used for a limited preview, for example of a small number of frames.

The above-described methods may require a memory to store very large files. By splitting file 200 into multiple parts, each of which is processed and transmitted as above in series (expect for the first block, whose transmission overlaps with a previous part), these memory requirements may be reduced.

Receiver-Transmitter Bandwidth Matching

Various other parameters of the above-described methods can be traded-off.

In an exemplary application, a receiver may be able to receive in parallel a plurality of storage streams and may require a memory buffer for each stream, to make disk access (e.g., for temporary storage of the stream) more efficient. Such a device (or transmission channel) may be limited, for example, in total receiver bandwidth availability, disk size, memory, number of streams that can be listened to in parallel and/or number of streams that can be written or read to the disk in parallel.

In some embodiments of the invention, if the number of received streams is smaller than the number of transmitted streams, the receiver receives as many streams (e.g., of the higher priority ones) as it can in parallel, and as one block is finished being received, disconnects that stream connects to the next one and starts receiving packets from it. For example a receiver may be only able to receive M times real time playback speed. While the information divided to K blocks is transmitted at N times real time playback speed (M<N). Such a receiver would connect to L streams where

$$L = ⌊ \frac{MK}{N} ⌋ ,$$

thus resulting with a delay time

$$DT = \frac{FS}{\frac{N}{K} {\sum }_{i = 0}^{⌊ \frac{K - 1}{L + 1} ⌋} {( - \frac{N}{K} )}^{i} \cdot ( {\sum }_{j = max \{ 0 , K - ( i + 1 ) ( L + 1 ) + 1 \}}^{K - i ( L + 1 ) - 1} ( \begin{matrix}j + i \\ i\end{matrix} ) {( 1 + \frac{N}{K} )}^{j} )}$$

It should be noted that this expression has a similar exponential behavior as does the theoretical limit described above. It should also be noted that M and N are not necessarily integers. In an exemplary application, by delaying longer than the theoretically expected delay time before starting displaying, the receiver can expect to have enough information for continuous display at any time. In an example, a 2 hour movie when N=7, if M=7 then an expected delay is 13.5 if M=1.5, then an expected delay is 114 sec.

The other limitations (e.g., disk r/w channels, memory and total bandwidth) can be translated into a limitation on the number of channels that can be effectively received at a time. Thus, it may be that a channel is not connected to (or data received at a lower rate by packet dropping) for lack of processing power at the receiver to handle the overhead of the extra channel, while reconstructing previously received channels.

It should be noted that even if M is close to 1, for example, 1.1 or 1.2, relatively short delays can be achieved, as shown by the above equation.

Size Factor

In an exemplary embodiment or the invention, some overhead time is provided for each received block to be reconstructed, thus allowing a non-ideal CPU to be used and/or allowing for temporary bad network conditions delaying packet reception. Alternatively or additionally, the received blocks are decoded continuously, preventing CPU load peaks.

In another exemplary tradeoff, if the reception time is slower than real-time playback, for a particular channel, the relative size factor is made smaller than 2. Alternatively or additionally, if the reception time is faster than real-time, the relative size factor is made greater than 2. It should be noted that in some embodiments of the invention, real time playback with relatively short delays are achieved even though each streaming channel is the same speed or slower than the playback speed.

In an exemplary embodiment of the invention, N=M, so L=K. The factor then may be, for example, 1+N/K.

Number of Actual Channels

In some applications, two or more of the streaming channels may be mixed into a single channel. Alternatively or additionally, some transmission channels may be faster than others (in practice). Optionally, the number of blocks, the size of the blocks and/or the relative size factors are dependent on the relative speed of the various channels. Possibly, the channel rates are monitored in real-time and the size of blocks modified accordingly, for example using distribution controller 106. In particular, the method of differential transmission rates for different parts of the file may be usefully applied using single channel multicasting, in which packets relating to different parts of the file are selected for transmission at a different relative rate.

Overlap Between Blocks

In some exemplary embodiments of the invention, the blocks do not overlap. Alternatively, there is at least some overlap between the blocks into which the file is divided. Alternatively or additionally, at least some of the bits in the file are encoded to have a higher probability of being decoded sooner than the rest of the file. This can allow beginning playback of the next block even before it is all received.

Alternatively or additionally, overlap between file blocks is provided by at least some of the packets being cross-block packets. Such packets can assist in reconstructing the next block. Alternatively or additionally, such packets can be directed to the beginning of the next block.

In an exemplary embodiment of the invention, cross-block packets use the solution of one channel to assist in solving equations for another channel.

Exemplary Applications

Referring back to FIG. 1, a distribution controller 106 may be provided to decide which data files are streamed and/or multicast and/or what expected delay to offer. Such a controller may base its actions, for example, on request and/or responses from receivers 104 and/or channel limitations. Controller 106 may also be used to allow receivers 104 to respond to the received data, for example, emulating an interactive HTTP connection.

In a particular example of cable television, a 128 minute movie may be provided with an expected delay of no more than 0.5 minutes, by broadcasting the movie on 8 regular channels, as described above. In a standard video on demand transmission method, where each channel transmits the whole movie, at a different start time, the expected delay is 16 minutes. The parallel-received blocks may be stored, for example, using a TiVo (or other television transmission recorder). Such broadcasting could also take advantage of methods known in the art for targeting only parts of the cable network. Alternatively or additionally, the multicasting is received at network nodes and then re-broadcast as needed. Although FEC coding may be used, in some embodiments of the invention, dropped frames may not be a problem and no coding is used. In some implementations, the data is encrypted and/or compressed prior to transmission.

In another exemplary embodiment, the communication network is a satellite, which typically has associated delay and link problems of sending a request for a specific media file.

In another example embodiment, the communication network is the Internet, where, for example, a movie server may desire to maintain constant data transmission rates, without being required to respond to requests by starting to send the same movie at multiple times. In some cases, when multiple requests arrive, additional channels are allocated to the movie, significantly reducing the expected delay time.

In another exemplary embodiment, the communication network is a cellular telephone network or a radio network, where a user may desire to flip between channels, and always start at a beginning of a presentation item.

Although a packet based transmission network may be used, the above method can also be applied to other types of networks, including both synchronous and asynchronous networks and packet based, switching based and/or continuous transmission networks. Also, the above method may be applied to both digital and analog communications.

Feedback for Channel Setup

In some of the above embodiments, the transmitter transmits an index of the channels and their mapping into media presentations. In some embodiments, controller 106, as described above, may use responses to this index, to decide which files to broadcast, at what rate, how many and which entry points and/or how many sections to divide the file into.

Channel Changing Support

In some embodiments of the invention, a receiver (e.g., a television, set top box or a computer) may record packets from a plurality of channels, thus allowing a rapid transition between a first channel and other channels. Alternatively or additionally, an exemplary channel may include some packets relating to other channels, for example channels of related content and/or language.

Update Using Differential Decoding

A feature of some types of broadcast channels is that their contents change only slowly over time. For example, news channels often continuously transmit a same content, while changing a small number of news items, every so often.

In an exemplary embodiment of the invention, a differential decoding ability is used to selectively receive and decode only enough packets for displaying the changes in an item. In one example of differential decoding, copies of previously received packets are stored, together with a code indicating the file version to which they apply. Only packets to the parts of the file updated in a newer version need to be downloaded and the old packets can be reused. Alternatively or additionally, the file itself is used as a partial solution for recovering data from received packets, thus reducing the number of packets to be decoded. This method can be used, for example, when a FEC is used, of the type where each packet is a XOR of a plurality of packets. The version number of such a packet is the newest version number of any block used for the packet. During reconstruction, a set of equations linking together blocks and packets is solved. The old data may be used to assist such a solution.

Two particular examples of such a slowly changing channel is the Internet WWW page of CNN (which is widely viewed) and the CNN daily continuous newscast. In addition to the changes caused by the change in news, some changes may occur as result of the personalization of the channel to a particular user and/or as a result of a request made by the user. By sending the channel using the methods described above, two advantages can be achieved. First, a short delay for retrieving most of the relevant channel is achieved, using a relatively low bandwidth. Thus, only the differences for particular viewers need to be sent. These differences can be sent, for example, by broadcast or by unicast (in Internet) or as data packets (in television) to be reconstructed by the receiver for the particular viewer. Alternatively or additionally, differential decoding can be used to allow a receiver to receive only a small number of packets and use these packets to display the personalized/changed page.

In one application, such a multicasting of WWW pages is used, together with a controller that receives responses from users, as a means for supporting an HTTP protocol using multicasting.

Update Using Preferential Encoding or Overriding

In some exemplary embodiments of the invention, instead of sending new replacement files or file parts, particular bits are over-ridden. In an exemplary embodiment of the invention, bits are overridden by providing new packets for the same bits, with other bit values. When solving the equations, the new bit values may be used in stead of the old ones. Alternatively or additionally, the new bit vales may be added to the old bit values, generating a set of over-constrained equations. If the new bits are in the majority, the solution will be the new data.

In an exemplary embodiment of the invention, the new bits are provided at a higher bit rate than other bits, for example, using preferential encoding techniques. Alternatively or additionally, whole packets including replacement bits are sent at a higher rate.

Optionally, a message indicating that old cross-packet buckets or old packets are stale is provided as well. Alternatively or additionally, a time period is defined, for example, in the data packets, that indicates that the packet is stale once the time passes, unless otherwise indicated A separate channel may be provided with such staleness indicators.

Alternatively or additionally, the new packets include, for example in the header, an indication that old packets are stale and/or that the new packet is a replacement packet. Alternatively or additionally, the packet includes an indication of the bit selection method used for the new packet, especially if a different type of preferential encoding is used.

Optionally, only the changed parts of the file are re-encoded and/or retransmitted, for example, trusting over-constraint solution methods to overcome ambiguities between data packets for different parts of the file and/or between cross-bucket packets and new packets.

RT Encoding

In an exemplary embodiment of the invention, the above data streaming methods are used for streaming of real-time generated data. In an exemplary embodiment of the invention, the current viewing time is considered an entry point where minimum delay is desired. This may be achieved for example, by using a minimum block size for the current data. Alternatively, data that is being transmitted as it is generated is not encoded using a FEC code, while earlier, previously data is FEC-encoded. This allows the current data to be displayed at a shorter delay or no delay.

Optionally, the beginning of the stream is also defined as an entry point. Possibly, additional entry points are defined. In a system that uses FEC-encoding for real-time data, the effective transmission rate of bits for the current time (as it moves into the past) goes down until a generally desired bit rate based on the position in the file is achieved. This reduction may be smooth or it may be step-wise.

In an exemplary embodiment of the invention, when a user joins a real-time event, the user receives data in parallel from multiple channels, possibly at a higher than the streaming data rate, possibly in order to catch-up with respect to acquiring the data stream. Alternatively or additionally, a user may activate fast forward and/or frame skipping functions (e.g., skip advertisements) in order that his display also catches up with the real-time event. Alternatively or additionally, a user can select a different starting point in the stream.

It should be noted that as an event unfolds, the channels that relate to later parts of the event cannot contain data for their respective parts. Such channels may be unused, maintained at a low data rate and/or used to assist in catching up, by transmitting unencoded information or provide additional bandwidth for transmitting previous information.

Optionally, as the stream continues to increase in duration, the transmission rate for all stream parts can be updated to reflect a desired reception and/or expected delay behavior, for example, using preferential encoding or transmission methods.

In an exemplary embodiment of the invention, a particular receiver may be viewing a rerun of the event, after many other viewers have viewed it. In an exemplary embodiment of the invention, the packet transmission probabilities are adapted to take into account sections where entry may be desirable and/or sections where a playback function is desirable. These sections may be selected by an operator and/or automatically responsive to requests from viewers.

In an exemplary embodiment of the invention, the above streaming methods are integrated with other data streaming methods. For example, alternatively or additionally to encoding using a FEC code, codes used for streaming, for example for compression, are used. Possibly, header sections of the stream and/or periodic key frames are transmitted on a high-priority channel, to allow reconstructing the stream, from its middle.

Multiple Transmitter Architecture

In some network types, instead of using a single transmitter, a plurality of transmitters may be provided, for example in different parts of the network, with each transmitter multicasting a different part of the file. Such a geographical dispersion may reduce bottlenecks in the network.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of transmitting a data file over a communication medium, comprising:
determining relative desired reconstruction time frames for different parts of the file;
allocating different transmission rates for the different parts of the file responsive to said determining;
dividing said file into sections;
encoding said sections using a FEC (forward error correction) code having the property that a file section can be reconstructed once a sufficient amount of encoded data relating to that data section is received; and
transmitting the encoded sections to have effective retransmission rates matching said different retransmission rates, such that said parts can be reconstructed in their respective desired time frame.

2. A method according to claim 1, where said sections have equal sizes.

3. A method according to claim 1, where said sections have unequal sizes.

4. A method according to claim 3, where the sizes of consecutive sections are related by a same factor.

5. A method according to claim 1, where said sections are transmitted at different retransmission rates.

6. A method according to claim 1, where said sections are transmitted at same retransmission rates.

7. A method according to claim 1, where said sections are transmitted as packets.

8. A method according to claim 7, where different packets from a same section are transmitted at a different rate.

9. A method according to claim 1, wherein said encoding represents at least one bit of a section at a higher effective rate that a different bit of said section.

10. A method according to claim 1, comprising receiving said stream using a receiver with an effective bandwidth more limited than the bandwidth used for said retransmission.

11. A method according to claim 10, wherein said receiver has an effective bandwidth less than 1.5 times a playback bandwidth required for real-time playback of said file and said retransmission has an effective bandwidth of over 2 times the playback bandwidth.

12. A method according to claim 10, wherein said receiver has an effective bandwidth less than 1.5 times a playback bandwidth required for real-time playback of said file and said retransmission has an effective bandwidth of over 4 times the playback bandwidth.

13. A method according to claim 1, wherein portions of said file in different sections overlap.

14. A method according to claim 1, wherein at least one of said encoded sections refers to content in more than one section.

15. A method of transmitting a data file over a communication medium, comprising:
determining relative desired reconstruction time frames for different parts of the file;
allocating different retransmission rates for the different parts of the file responsive to said determining so that an effective retransmission rate varies on a bit by bit basis; and
transmitting the file so that said different parts have effective retransmission rates matching said different retransmission rates, such that said parts can be reconstructed in their respective desired time frame.

16. A method of transmitting a data file over a communication medium, comprising:
determining relative desired reconstruction time frames for different parts of the file;
allocating different retransmission rates for the different parts of the file responsive to said determining so that retransmission rate varies continuously on a data block by data block basis; and
transmitting the file so that said different parts have effective retransmission rates matching said different retransmission rates, such that said parts can be reconstructed in their respective desired time frame.

17. A method of transmitting a data file over a communication medium, comprising:
determining relative desired reconstruction times for different parts of the file;
differentially allocating different retransmission rates for the different parts of the file responsive to said determining;
dividing the file into sections; and
transmitting the file so that said different parts have effective retransmission rates matching said different retransmission rates, said retransmission using a multi-layer retransmission scheme, such that said parts can be reconstructed in their respective desired time frame.

18. A method according to claim 17, wherein said different layers contain the same data.

19. A method according to claim 17, wherein said different layers contain data, to allow bandwidth dependent reception of different levels of reception quality, dependent on the bandwidth received by a receiver.

20. A method according to claim 17, wherein transmitting comprises encoding said sections using a FEC (forward error correction) code having the property that a file section can be reconstructed once a sufficient amount of encoded data relating to that data section is received.

21. A method of transmitting a data file over a communication medium, comprising:
determining relative desired reconstruction time frames for different parts of the file;
differentially allocating different retransmission rates for the different parts of the file responsive to said determining;
dividing the file into sections having different sizes; and
transmitting the sections to have effective retransmission rates matching said different retransmission rates.

22. A method according to an), of claims 1-21, wherein said transmitting is oblivious to a time of commencement of said receiving.

23. A method according to claim 22, wherein transmitting comprises multicasting.

24. A method according to any of claims 1-21, wherein said data file comprises a video stream.

25. A method according to any of claims 1-21, wherein said data file comprises an audio stream.

26. A method according to any of claims 1-21, wherein said data file comprises a streaming media.

27. A method according to any of claims 1-21, wherein said data file comprises a real-time stream.

28. A method of transmitting and receiving a data file in a manner oblivious to a time of commencement of reception by a receiver, comprising:
transmitting a file, using a retransmission bandwidth, such that different parts of the file are retransmitted at different rates; and
receiving said file using an effective reception bandwidth, smaller than said retransmission bandwidth, said transmitting being oblivious to a time of commencement of said receiving; and
commencing continuous playback of said file, at a delay from said retransmission, wherein said reception bandwidth is less than 80% of said retransmission bandwidth and wherein a ratio between said delay and a playback time of said file is smaller than 80% of a ratio between said reception bandwidth and said retransmission bandwidth.

29. A method according to claim 28, wherein said reception bandwidth is less than 50% of said retransmission bandwidth.

30. A method according to claim 28, wherein said reception bandwidth is less than 20% of said retransmission bandwidth.

31. A method according to claim 28, wherein said reception bandwidth is less than 200% of a bandwidth required for smooth playback of said file using a synchronized transmission method.

32. A method according to claim 28, wherein said reception bandwidth is less than 150% of a bandwidth required for smooth playback of said file using a synchronized transmission method.

33. A method according to claim 28, wherein said reception bandwidth is less than 130% of a bandwidth required for smooth playback of said file using a synchronized transmission method.

34. A method according to claim 28, wherein said transmission is a multi-channel transmission and wherein said receiver is limited in a number of channels it can receive, said number being smaller than the number of channels being used for transmission.

35. A method according to claim 28, wherein receiving comprises optimizing said receiving, within the limits of said effective reception bandwidth to minimize said delay.

36. A method according to claim 28, wherein receiving comprises limiting said reception to data required for current playback and for temporally sequential playback.

37. A method of streaming real-time data, as it is being provided, comprising:
providing an input stream of real-time data;
generating packets based on said real-time data; and
transmitting, in parallel, packets relating to a time frame of said stream and to a previous time-frame of said stream, such that packets are transmitted at an effective bit retransmission rate depending on a relative time frame of data in said packets.

38. A method according to claim 37, wherein generating comprises encoding said data using FEC (forward error correction) code having the property that a file section can be reconstructed once a sufficient amount of encoded data relating to that data section is received.

39. A method according to claim 38, wherein generating comprises generating unencoded packets for current time frame packets.

40. A method according to claim 37, wherein the effective retransmission rates are selected so that at least one entry point in said stream will be retransmitted at a higher effective retransmission rate than non-entry points of said stream and data from time frames following said at least one entry point will have monotonicly decreasing effective retransmission rates, at least until a next entry point.

41. A method according to claim 40, wherein the current time frame is an entry point.

42. A method according to claim 40, wherein the beginning of the stream is an entry point.

43. A method according to claim 37, wherein transmitting comprises transmitting different packets at different repetition rates

44. A method according to claim 37, wherein transmitting comprises preferentially selecting some data over others in a generation of said packets for transmission.

45. A method of transmitting a data file over a communication medium, comprising:
determining relative desired reconstruction time frames for different parts of the file;
differentially allocating different retransmission rates for the different parts of the file responsive to said determining; and
transmitting the file so that said different parts have effective retransmission rates matching said different retransmission rates, over a channel with a varying bandwidth.

46. A method according to claim 45, comprising dividing the file into sections, each of which is transmitted at a different effective retransmission rate.

47. A method according to claim 46, wherein at least two of said sections include an overlapping part of said file.

48. A method according to claim 46, comprising generating data packets including contributions from different sections.

49. A method according to claim 45, comprising:
receiving said transmission; and
commencing playback of said file, as it is being received, at a delay relative to said reception, said delay being smaller than that required for receiving 50% of said file.

50. A method according to claim 49, comprising selecting said delay responsive to expected variations in said bandwidth.

51. A method according to claim 49, comprising selecting said relative retransmission rates responsive to expected variations in said bandwidth.

52. A method according to claim 49, comprising modifying a quality of data in said transmission responsive to expected variations in said bandwidth.
